(19) United States
(12) Patent Application Publication
(10) Pub. No.: US 2026/0004289 A1
(43) Pub. Date: Jan. 1, 2026

(54) Off-Chain Gas Management System and Method

(71) Applicant: Alchemy Insights, Inc., San Francisco, CA (US)

(72) Inventors: Fangting Liu, Seattle, WA (US); Adam Peter Egyed, New York, NY (US); Malak Mekhael, Sunnyvale, CA (US); Daniel Coombs, Park Ridge, IL (US)

(21) Appl. No.: 19/249,123

(22) Filed: Jun. 25, 2025

Related U.S. Application Data
(60) Provisional application No. 63/664,670, filed on Jun. 26, 2024.

(51) Int. Cl. G06Q 20/38; G06F 9/54; G06Q 20/40; G06Q 30/04

(52) U.S. Cl. CPC G06Q 20/389; G06F 9/547; G06Q 20/401; G06Q 20/405; G06Q 30/04

(57) ABSTRACT

An off-chain gas management system allows Web3 developers to cover gas fees for their users. When a user wants to complete a blockchain transaction, the system receives a sponsorship request through an API and checks if the operation qualifies under the developer's gas sponsorship policy. Policies include spending limits, approved addresses, and time restrictions. If approved, the system creates a cryptographic signature that authorizes transfer of the gas fee amount. An on-chain contract validates the signature before covering the gas fees. The system includes a user interface for creating and managing policies with configurable spending controls and address restrictions. Advanced features use machine learning to allocate funds based on user value, detect fraud, classify transaction types, optimize cryptocurrency purchases, and predict when funds will run out. This eliminates the barrier of users needing to own cryptocurrency to pay gas fees while maintaining security through automated policy enforcement and cryptographic validation.

### CROSS-REFERENCE TO RELATED APPLICATIONS

The present application claims the priority benefit of U.S. Provisional Patent Application No. 63/664,670, filed Jun. 26, 2024, which application is incorporated by reference in its entirety herein.

### FIELD OF THE INVENTION

The present application relates to the field of blockchain technologies, and specifically to a system, method, and storage medium to enable the sponsorship of gas fees for Web3 application users.

### BACKGROUND

Blockchain networks generally require what is known as a “gas fee,” or transmission of a cryptocurrency token in order to record information to the relevant blockchain via “blockchain transactions.” In effect, gas fees represent the cost of using computational resources on the blockchain. This feature has the advantage of minimizing issues such as distributed denial of service attacks, where malicious actors attempt to overload the network with transactions that consume excessive resources. By requiring gas fees, the blockchain network ensures that resources are allocated efficiently and fairly among users, preventing any single user from monopolizing resources at the expense of others. Furthermore, by collecting gas fees, the blockchain network can use the collected funds to reward participants in the blockchain network such as validators who contribute to the recording of information on the blockchain. The collection of gas fees also ensures that the network has a sustainable economic model to continue operating.

One of the key challenges from the perspective of a user interacting with a decentralized application (dApp) is that gas fees can fluctuate based on network congestion and demand, making it challenging for users to predict the costs associated with interacting with dApps or executing blockchain transactions.

Gas limit management is a critical aspect of maintaining the health and efficiency of a blockchain network. In blockchain networks like Ethereum, each transaction or smart contract execution consumes a certain amount of computational resources, measured in gas. The management of gas limits occurs at both the individual user and network level. For transactions submitted by a user to a blockchain network, a gas limit is the maximum amount of gas that a transaction can use for executing a transaction or smart contract. This gas limit is set by the user.

In addition, the blockchain network will enforce a block gas cap, which limits the amount of gas that can be used in a single block and ensures that resources are allocated efficiently and fairly among users, preventing any single user from monopolizing resources at the expense of others.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The off-chain gas management system of the present disclosure provides significant operational advantages for Web3 enterprises seeking to optimize user acquisition and retention. Blockchain applications typically require users to acquire, manage, and spend native cryptocurrencies for gas fees associated with recording blockchain transactions, creating substantial barriers to adoption among mainstream users unfamiliar with cryptocurrency ecosystems. The disclosed system addresses this impediment by enabling decentralized applications (dApps) to sponsor user gas fees through configurable off-chain policies, thereby eliminating the need for users to engage in complex fee management efforts. The system incorporates enhanced security mechanisms through cryptographic transaction authentication and conditional payment execution, ensuring that sponsored gas fees for transactions are processed only when predetermined criteria are satisfied, which substantially mitigates fraud risk and operational errors. Additionally, the system provides developers with granular control through customizable sponsorship rules, enabling precise definition of sponsorship conditions, transaction types, user eligibility criteria, and fee limits. This programmatic flexibility allows dApp operators to implement strategic gas fee policies that align with their business objectives while maintaining cost predictability and user experience consistency.

A “Wallet Service” refers to a digital tool or application in the blockchain ecosystem that allows users to store, manage, and transact with their cryptocurrency assets. These services provide a user-friendly interface for interacting with blockchain networks and come with various features for enhancing security, usability, and accessibility, such as, for example, wallet creation and management, transaction handling, security features, integration capabilities, user experience enhancements and analytics and reporting. The present disclosure addresses a user experience enhancement aspect of the Wallet Services offerings. Specifically, the present disclosure discloses a Wallet Service feature that improves the user blockchain experience. Specifically, a Wallet Service feature is disclosed herein related to an off-chain gas management system, method, tool and computer medium that allows dApp developers to cover users' gas fees required for sending transactions.

In some embodiments, the present disclosure is directed to a computer implemented method, comprising: receiving, via a sponsorship API, a sponsorship request for a user operation from a developer application; determining, by evaluating the user operation against a developer's off-chain gas sponsorship policy, whether the requested user operation should be sponsored, the off-chain gas sponsorship policy comprising configurable rules including spending limits, address controls, and temporal parameters; generating, when the user operation is determined to qualify for sponsorship, a cryptographic authentication signature that authorizes gas fee coverage for the user operation; and validating, via an ERC-4337 verifying paymaster smart contract, the authentication signature prior to covering gas fees for the authorized user operation.

In some embodiments, the present disclosure is directed to a system, comprising: a processor; and a memory for storing instructions, the instructions being executed by the processor to: receive, via a sponsorship API, a sponsorship request for a user operation from a developer application; determine, by evaluating the user operation against a developer's off-chain gas sponsorship policy, whether the requested user operation should be sponsored, the off-chain gas sponsorship policy comprising configurable rules including spending limits, address controls, and temporal parameters; generate, when the user operation is determined to qualify for sponsorship, a cryptographic authentication signature that authorizes gas fee coverage for the user operation; and validate, via an ERC-4337 verifying paymaster smart contract, the authentication signature prior to covering gas fees for the authorized user operation.

In some embodiments, the present disclosure is directed to a method, comprising: providing a user interface configured to receive policy creation inputs; receiving policy configuration data comprising a policy name and an identifier of an associated application; configuring spending control parameters comprising maximum monetary amounts per transaction, maximum monetary amounts per user operation, maximum aggregate monetary amounts per time period, maximum number of user operations per address, and maximum number of user operations per policy; configuring wallet address control parameters comprising at least one of: (i) a wallet address allowlist that restricts usage of the off-chain gas sponsorship policy to predetermined authorized wallet addresses, or (ii) a wallet address blocklist that excludes predetermined prohibited wallet addresses from the gas sponsorship policy; defining temporal control parameters comprising a policy duration period during which the gas sponsorship policy will remain in effect, and one or more sponsorship expiry periods that define time limits for authentication signatures to remain valid after generation; validating the policy configuration through a policy engine that retrieves applicable policies from a policy database and enforces policy rules; storing the policy in the policy database and marking the policy as active for operational use upon successful validation; associating the policy with the associated application through the application's API key such that the policy accepts only requests sent through the API key of the associated application and rejects all other requests; implementing API key verification mechanisms via an API gateway and sponsorship service to automatically reject requests from unauthorized applications; and providing policy management tools through the user interface for editing and updating published policies, wherein policy modifications trigger re-validation through the policy engine before becoming effective.

In some embodiments, the present disclosure is directed to a system, comprising: a processor; and a memory for storing instructions, the instructions being executed by the processor to: provide a user interface configured to receive policy creation inputs; receive policy configuration data comprising a policy name and an identifier of an associated application; configure spending control parameters comprising maximum monetary amounts per transaction, maximum monetary amounts per user operation, maximum aggregate monetary amounts per time period, maximum number of user operations per address, and maximum number of user operations per policy; configure address control parameters comprising at least one of: (i) an address allowlist that restricts usage of the off-chain gas sponsorship policy to predetermined authorized wallet addresses, or (ii) a wallet address blocklist that excludes predetermined prohibited wallet addresses from the gas sponsorship policy; define temporal control parameters comprising a policy duration period during which the gas sponsorship policy will remain in effect, and one or more sponsorship expiry periods that define time limits for authentication signatures to remain valid after generation; validate the policy configuration through a policy engine that retrieves applicable policies from a policy database and enforces policy rules; store the policy in the policy database and mark the policy as active for operational use upon successful validation; associate the policy with the associated application through the application's API key such that the policy accepts only requests sent through the API key of the associated application and rejects all other requests; implement API key verification mechanisms via an API gateway and sponsorship service to automatically reject requests from unauthorized applications; and provide policy management tools through the user interface for editing and updating published policies, wherein policy modifications trigger re-validation through the policy engine before becoming effective.

In some embodiments, the present disclosure is directed to a non-transient computer-readable storage medium including instructions being executable by one or more processors to perform operations comprising: receiving, via a sponsorship API, a sponsorship request for a user operation from a developer application; determining, by evaluating the user operation against a developer's off-chain gas sponsorship policy, whether the requested user operation should be sponsored, the off-chain gas sponsorship policy comprising configurable rules including spending limits, address controls, and temporal parameters; generating, when the user operation is determined to qualify for sponsorship, a cryptographic authentication signature that authorizes gas fee coverage for the user operation; and validating, via an ERC-4337 verifying paymaster smart contract, the authentication signature prior to covering gas fees for the authorized user operation.

In some embodiments, the present disclosure is directed to a non-transitory computer-readable storage medium storing instructions that, when executed by one or more processors, cause the processors to perform operations comprising: providing a user interface configured to receive policy creation inputs; receiving policy configuration data comprising a policy name and an identifier of an associated application; configuring spending control parameters comprising maximum monetary amounts per transaction, maximum monetary amounts per user operation, maximum aggregate monetary amounts per time period, maximum number of user operations per address, and maximum number of user operations per policy; configuring address control parameters comprising at least one of: (i) a wallet address allowlist that restricts usage of the off-chain gas sponsorship policy to predetermined authorized wallet addresses, or (ii) a wallet address blocklist that excludes predetermined prohibited wallet addresses from the gas sponsorship policy; defining temporal control parameters comprising a policy duration period during which the gas sponsorship policy will remain in effect, and one or more sponsorship expiry periods that define time limits for authentication signatures to remain valid after generation; validating the policy configuration through a policy engine that retrieves applicable policies from a policy database and enforces policy rules; storing the policy in the policy database and marking the policy as active for operational use upon successful validation; associating the policy with the associated application through the application's API key such that the policy accepts only requests sent through the API key of the associated application and rejects all other requests; implementing API key verification mechanisms via an API gateway and sponsorship service to automatically reject requests from unauthorized applications; and providing policy management tools through the user interface for editing and updating published policies, wherein policy modifications trigger re-validation through the policy engine before becoming effective

In some embodiments, an off-chain gas management system may comprise: a gas policy management module, a gas estimation module, a gas pricing module, a gas limit management module, and a gas optimization module.

In some embodiments, the off-chain gas management system and method described herein may be implemented by an infrastructure provider, allowing dApps to sponsor gas fees on behalf of their users, effectively covering the cost of gas required for user operations or smart contract interactions.

In some embodiments, certain rules may be implemented for establishing and/or maintaining a gas sponsorship policy.

In some embodiments, the off-chain gas management system is configured to generate a gas sponsorship policy for a Web3 application developer, for defining: one or more spending rules that limit the amount of money or the number of user operations that are allowed to be authorized by the off-chain gas sponsorship policy; one of an allowlist to allow the usage of the off-chain gas sponsorship policy to a list of specific addresses or a blocklist to exclude a list of certain addresses from the policy; and a policy duration period during which the gas sponsorship policy will be in effect.

In some embodiments, the gas estimation module is configured to estimate the amount of gas required to execute a transaction or a smart contract based on its computational complexity and the resources it consumes.

In some embodiments, the gas pricing module is configured to determine the appropriate gas price (the cost per unit of gas) for transactions based on network conditions such as congestion and demand.

In some embodiments, the gas limit management module is configured to set a maximum limit on the amount of gas that can be consumed by a transaction or a smart contract execution, to prevent malicious or poorly optimized code from exhausting network resources.

In some embodiments, the gas optimization module is configured to provide tools or techniques to optimize smart contracts and transactions to minimize gas consumption, thus reducing transaction costs for users.

In some embodiments, the off-chain gas sponsorship policy may be implemented as part of the blockchain client software or as a separate library or module that interacts with the blockchain network.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

These and other objects, features and advantages of the present disclosure will be better understood from the detailed description of preferred embodiments and examples thereof that follows with reference to the accompanying drawings, in which:

FIG. 1 is a system diagram of an off-chain gas management system.

FIG. 2 is a flowchart illustrating an off-chain sponsorship API process, according to exemplary embodiments.

FIG. 3 is a flowchart illustrating steps to create an off-chain gas sponsorship policy in accordance with the off-chain sponsorship API process of FIG. 2, according to exemplary embodiments.

FIGS. 4-9 are screenshots of a process of registering and creating the off-chain gas sponsorship policy of FIG. 2, according to exemplary embodiments.

FIGS. 10-15 are flow diagrams of AI processes for detecting and limiting fund usage via adaptive learning, according to exemplary embodiments.

FIG. 16 is a screenshot of an exemplary computer system that is used to implement embodiments according to the present technology.

### DEFINITIONS

In blockchain technology, operations and data are categorized as either ‘on-chain,’ referring to activities that occur directly on the blockchain network and are recorded in the distributed ledger, or ‘off-chain,’ referring to activities that occur outside the blockchain network without being permanently recorded on the distributed ledger.

### On-Chain (Network) Definitions

The term “transaction” in blockchain is a cryptographically signed data structure that represents a state change or action within the network and is typically initiated by an externally owned account (EOA). Transactions require a signature from a private key associated with the EOA and usually involve transferring value or interacting with smart contracts. Transactions require gas fees to be paid up front by the sender and are executed directly by the blockchain network. A transaction in Ethereum typically includes: a sender wallet address, a recipient wallet address, the amount of Ether to transfer (if any), data payload (optional, used for interacting with smart contracts), gas limit (maximum amount of computational work the transaction can use), gas price (the amount of Ether the sender is willing to pay per unit of gas), and nonce (a sequence number for the transaction).

The term “user operation” in blockchain is a more recent concept that is particularly relevant in the context of account abstraction, which refers to reducing the complexity associated with users' ability to use dApps. User operations are designed to be more flexible than blockchain transactions, allowing for features like sponsored transactions, batched operations, and more complex account structures. According to ERC-4337 V0.6, a “user operation” is defined as follows: A user operation is a structure that represents an action a user wants to perform on the Ethereum network. A user operation includes:
1. Sender (address): The address of the smart contract account that will execute the operation.
2. Nonce: A number that prevents replay attacks.
3. InitCode: Code used to deploy the account if it doesn't exist yet.
4. CallData: The actual operation to be executed.
5. CallGasLimit: Maximum gas that can be used for the main execution.
6. VerificationGasLimit: Maximum gas for verification function calls.
7. Pre VerificationGas: Gas paid for overhead operations.
8. MaxFeePerGas: Maximum fee the user is willing to pay per gas unit.
9. MaxPriorityFeePerGas: Maximum priority fee per gas unit.
10. PaymasterAndData: Optional EIP-4337 Verified Paymaster contract address and additional data.
11. Signature: Signature authorizing the operation.

User operations can be initiated by smart contract wallets or other abstracted accounts and may not require a direct signature from an EOA. Gas fees can potentially be paid by a third party or through alternative mechanisms. User operations are often bundled and processed by intermediate entities (e.g., Alchemy) before reaching the blockchain. Specifically, user operations might go through additional layers (like bundlers in EIP-4337) before reaching the blockchain. Unlike standard “transactions” that are universally supported by all blockchain networks, user operations require specific support and infrastructure. Throughout this disclosure, all references to “user operations” shall also be deemed to refer to “transactions” as gas fee management and gas sponsorship can be applied to both.

The term “gas” is a unit of measurement used to quantify the computational effort required to perform operations on a blockchain network, such as executing smart contracts or processing transactions. Each operation on the blockchain consumes a certain amount of gas, and users must pay for this gas in cryptocurrency (e.g., Ether in the case of Ethereum) to incentivize network miners or validators to process their transactions.

The term “on-chain gas limit management” at the block level of a blockchain network is a crucial mechanism to protect block chain networks against denial of service (DOS) attacks by enforcing on-chain gas limit management. A network-specific virtual machine (VM) plays a crucial role in enforcing gas limits (for example, for Ethereum, the Ethereum Virtual Machine). The VM maintains a gas counter for each transaction operation execution. The counter starts at the gas limit specified in the user operation and decreases as operations are performed. Each operation in the VM (e.g., addition, storage, memory access) has a predefined gas cost. Before executing an operation, the VM checks if there is enough gas remaining. As each operation is executed, its gas cost is deducted from the remaining gas. Before each operation, the VM checks if the remaining gas is sufficient. If an operation would cause gas to go negative, the VM halts executing the current transaction and all state changes made by the partial execution are reverted.

### Off-Chain Definitions

The term “off-chain gas limit management” refers to a property of an off-chain gas sponsorship policy directed to ensuring accurate gas limit estimation for transactions (or user operations) to enable proper sponsorship eligibility determination. More particularly, off-chain gas limit management does not address strict gas limit enforcement issues handled by the network, as defined above. Rather, gas limit management, as defined herein, is a novel feature of the present disclosure directed to setting accurate gas limits that reflect the actual resources a transaction (or user operation) will consume on-chain, thereby ensuring that transactions (or user operation) eligible for sponsorship based on their true resource consumption are properly recognized as such during off-chain policy evaluation. In one aspect, accurate gas limit estimation per transaction (or user operation) may be managed by the off-chain gas sponsorship policy by estimating how much gas a particular transaction (or user operation) will use and adding some additional overhead (e.g., 25%-50%) to the estimated usage amount to establish a reliable gas limit that accurately represents the transaction's (or user operation's) resource requirements for sponsorship determination purposes.

The term “gas price calculation” refers to the off-chain gas sponsorship policy suggesting or determining the optimal gas price to include in a user operation based on the current network conditions. A higher gas price incentivizes miners or validators to prioritize the user operation for faster processing.

The term “gas optimization” refers to those cases where the off-chain gas sponsorship policy may implement strategies to optimize gas usage, such as breaking down large user operations into smaller ones or batching multiple operations to reduce the overall gas cost.

The term “dApp” is shorthand for decentralized application and may be defined as a type of application that runs on a decentralized network rather than a centralized server. These applications are built on blockchain technology, which ensures transparency, immutability, and security through its decentralized nature. A dApp typically has its backend code running on a decentralized peer-to-peer network, such as Ethereum or Solana, and uses smart contracts to execute logic and store data securely on the blockchain. This decentralization removes the need for intermediaries or centralized control, allowing for greater transparency and censorship resistance.

The term: “Spending rules” limits the amount of money or the number of user operations that can be sponsored by an off-chain gas sponsorship policy.

The term “Allowlist” restricts wallet addresses that are eligible for gas payment sponsorship. The policy will only sponsor gas for unspent outputs that were sent by addresses on the Allowlist.

The term “Blocklist” bans certain addresses from receiving sponsorship under an off-chain gas sponsorship policy.

The term “Sponsorship expiry period” is the period for which the off-chain gas sponsorship policy signature will remain valid once it is generated.

### DETAILED DESCRIPTION OF EXAMPLE EMBODIMENTS

The present disclosure and examples thereof will now be described more fully in detail hereinafter.

In addition, the terminology used herein for the purpose of describing particular embodiments of the present technology is to be taken in context. For example, the term “comprises” or “comprising” when used in this disclosure indicates the presence of stated features in a system or steps in a process but does not preclude the presence of additional features or steps.

### Overview

The present disclosure describes an off-chain gas management system, methods, and non-transitory computer-readable storage medium for reducing the complexity of blockchain interactions by enabling Web3 application developers to sponsor their users' gas fees. Blockchain networks generally require users to directly own and manage native cryptocurrencies (e.g., Ether for Ethereum) to pay transaction fees, creating significant barriers to user adoption and seamless application experiences. The disclosed system addresses this challenge by abstracting away from users the complexity of gas fee management through automated estimation of gas limits and fees, coupled with configurable sponsorship policies that allow developers to cover gas fees on behalf of their users. This approach enables developers to attract broader user bases and deliver streamlined user experiences comparable to traditional web applications, while maintaining the underlying security and decentralization benefits of blockchain technology.

The off-chain gas sponsorship policy implemented by the off-chain gas management system of the present disclosure advantageously enhances Web3 accessibility by eliminating the prerequisite for users to acquire, hold, or directly manage native cryptocurrencies for gas fee payments. The system enables decentralized applications (dApps) to abstract away the complexity of users dealing with gas fees through automated off-chain policy execution, thereby providing a streamlined user experience that removes traditional barriers to blockchain interaction. By decoupling transactions (and user operations) from direct gas fee management, the disclosed system facilitates broader participation in decentralized ecosystems without requiring users to navigate cryptocurrency acquisition processes, wallet funding procedures, or gas fee estimation. This technical advancement addresses a significant adoption impediment in blockchain technology, enabling more intuitive user interfaces that resemble traditional web applications while maintaining the security and decentralization benefits of blockchain networks.

### EXAMPLE EMBODIMENTS

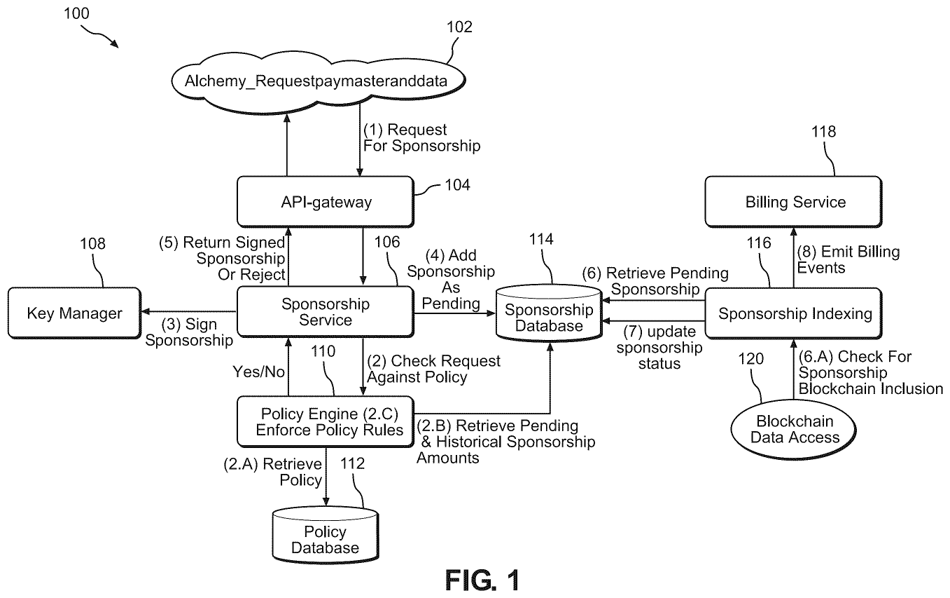

Turning now to the drawings, FIG. 1 illustrates an exemplary system architecture for implementing aspects of a gas sponsorship system 100 of the present disclosure. The system architecture includes an API gateway 104 that is shown to interfaces with an Alchemy_Requestpaymasteranddata cloud service 102, a Sponsorship Service 106 connected to a Policy Engine 110 and Policy Database 112, a Key Manager 108, a Sponsorship Database 114, Sponsorship Indexing 116, Blockchain Data Access 120, and a Billing Service 118, all working together to process sponsorship requests, enforce policy rules, and manage gas fee sponsorship.

The gas sponsorship system 100 operates through three distinct phases: an Initial Request Processing Phase that handles incoming sponsorship requests and validates them through the web gateway, a Policy Evaluation and Authorization Phase that enforces business rules and generates cryptographic commitments, and a Blockchain Monitoring and Settlement Phase that tracks transaction confirmations and manages final billing.

### Initial Request Processing Phase

The system 100 initiates operation when an external application programming interface (API) receives a request for gas sponsorship through the alchemy.requestPaymasterAndData endpoint 102 (e.g., See (1) Request for Sponsorship). This endpoint 102 serves as the primary ingress point for applications seeking to obtain sponsorship authorization for blockchain transactions requiring gas fee payment. The incoming request contains transaction parameters and user identification information necessary for sponsorship evaluation.

The incoming request is subsequently routed through a web gateway module 104 that provides load balancing, request validation, and traffic management capabilities. The web gateway module 104 ensures system scalability and reliability by distributing incoming requests across available service instances and performing initial request sanitization before forwarding the requests to downstream processing components.

Upon receiving the validated request from the web gateway module 104, the Central Sponsorship Service module 106 orchestrates the sponsorship evaluation workflow (e.g., See (4) Add Sponsorship As Pending). This service acts as the primary coordination layer, managing the interaction between various system components required to make sponsorship decisions. The Sponsorship Service module 106 maintains the business logic for processing sponsorship requests and coordinates with policy enforcement and cryptographic signing components.

### Policy Evaluation and Authorization Phase

The Sponsorship Service module 106 queries the Policy Engine module 110 to determine whether the requested sponsorship complies with established sponsorship policies (e.g., See (2) Check Request Against Policy). In response to the query from the Sponsorship Service Module 106, the Policy Engine module 110 retrieves applicable policies from the Policy Database 112 (e.g., See (2.A) Retrieve Policy), which stores configurable rules such as spending limits per user, transaction (or user operation) value thresholds, rate limiting parameters, and other business-specific constraints. The policy evaluation process ensures that sponsorship decisions align with the sponsor's risk management requirements and budget constraints. The Policy Engine module 110 also retrieves pending and historical sponsorship amounts for evaluation (e.g., See (2.B) Retrieve Pending & Historical Sponsorship Amounts) from the Sponsorship database 114 and enforces policy rules (e.g., See (2.C) Enforce Policy Rules)

When the Policy Engine module 110 determines that a sponsorship request satisfies all applicable policies, the system proceeds to generate cryptographic authorization. The Key Manager module 108 utilizes securely stored private keys to digitally sign the sponsorship commitment (e.g. See (3) Sign Sponsorship), creating a cryptographically verifiable authorization that can be subsequently used to execute the sponsored transaction (or user operation) on the blockchain network. This digital signature serves as proof of the sponsor's commitment to pay the associated gas fees. The system then returns the signed sponsorship or rejection response (e.g., See (5) Return Signed Sponsorship or Reject).

The successfully authorized sponsorship, including its cryptographic signature and associated metadata, is stored in the Sponsorship Database 114 with a “pending” status. This database serves as the system's state repository, tracking all sponsorship commitments from initial authorization through final settlement. The pending status indicates that while authorization has been granted, the corresponding blockchain transaction has not yet been confirmed on-chain.

### Blockchain Monitoring and Settlement Phase

Operating independently of the request processing workflow, the Sponsorship Indexing service module 116 continuously monitors the blockchain network for events corresponding to pending sponsorships stored in the Sponsorship Database 114 (e.g., See FIG. 1, item (6) Retrieve Pending Sponsorship). This service implements blockchain event indexing functionality, systematically s canning blockchain data to identify when sponsored transactions are successfully included in confirmed blocks. The indexing process checks for sponsorship blockchain inclusion (e.g., See FIG. 1, item (6.A) Check for sponsorship Blockchain Inclusion) and utilizes the Blockchain Data Access module 120 to interface with blockchain network nodes and retrieve transaction confirmation data.

Upon detecting that a sponsored transaction has achieved on-chain confirmation, the Sponsorship Indexing module 116 updates the corresponding record in the Sponsorship database 114, changing its status from “pending” to “finalized” (e.g., See FIG. 1, item (7) update sponsorship status). This status change reflects the successful completion of the sponsored transaction and triggers the initiation of the billing process. The system 100 implements configurable timeout mechanisms to handle cases where sponsored transactions fail to achieve confirmation within specified time periods, preventing indefinite pending states.

Following successful transaction confirmation and database status updates, the system 100 generates billing events that are transmitted to the Billing Service module 118 (e.g., See FIG. 1, item (8) Emit Billing Events). The Billing Service module 118 processes these events to calculate actual gas costs incurred and charges the appropriate sponsor account. This deferred billing approach ensures that sponsors are charged only for successfully completed transactions, avoiding charges for failed or unconfirmed sponsorship attempts. The billing process completes the end-to-end sponsorship workflow, from initial authorization through final cost settlement.

### Off-Chain Gas Sponsorship Policy

The off-chain gas sponsorship policy is designed to provide developers with configurable rules for conditionally sponsoring transactions (or user operations) while ensuring accurate gas limit and fee estimation. The gas sponsorship policy of the present disclosure enables developers to define specific criteria that determine when they will cover gas costs for their users' blockchain transactions (or user operations0, streamlining the user experience without requiring direct interaction with underlying blockchain network economics.

Gas management is performed by a sponsoring gas manager module and includes operational functions and policy enforcement functions such as:

### Operational Functions:

1. Gas Estimation-estimating the amount of gas required to execute a transaction, user operation, or smart contract based on its computational complexity and the resources it consumes.
2. Gas Fee Estimation-determining gas pricing based on gas limits and gas fees (i.e., the cost per unit of gas), where gas limits may be determined by gas limit management techniques that set a maximum limit on the amount of gas that can be consumed by a transaction, user operation, or smart contract execution.

### Policy Enforcement Functions:

1. Gas Sponsorship (on-chain component)—the gas manager system determines that the gas fee for a transaction (or user operation) will be paid for (sponsored) if the transaction (or user operation) is authorized by the off-chain policy engine. Otherwise, it will revert.
2. Gas Sponsorship (off-chain component)—comprising the whole policy engine which is a part of the authorization engine. A transaction (or user operation) will only obtain a valid authorization signature the user can send to the on-chain component if the transaction (or user operation) passes the gas sponsorship policy criteria for the user. Gas sponsorship policy criteria is defined below.

In some embodiments, the off-chain gas sponsorship policy may include one or more of the following configurable sponsorship criteria:
1. Gas Limit Constraints: This specifies the maximum amount of gas that can be sponsored for a transaction, user operation, or smart contract execution. Setting an appropriate gas limit prevents excessive resource consumption from sponsorship and helps mitigate denial of service attacks.
2. Gas Price Thresholds: The policy defines sponsorship eligibility based on gas prices. The policy may specify maximum gas price thresholds or other pricing criteria that determine when transactions or user operations qualify for sponsorship.
3. Gas Optimization Requirements: Sponsorship criteria for smart contracts and transactions or user operations that must meet certain gas consumption efficiency standards. This may include requirements for efficient code and gas-efficient operations as a condition for sponsorship eligibility.
4. Dynamic Adjustment: Policies may include mechanisms for dynamically adjusting sponsorship criteria based on real-time network conditions. This flexibility helps maintain optimal sponsorship decision-making and responsiveness.
5. Security Considerations: Policies may also address security concerns related to sponsored gas usage, such as preventing sponsorship abuse or ensuring fair and equitable access to sponsored network resources

### Off-Chain Gas Sponsorship API

Having described the technical architecture and operational workflow of the gas sponsorship system 100, the following section details the off-chain gas sponsorship policy that governs the decision-making processes within the Gas Policy Engine module 110 and ensures optimal resource allocation across the system.

The sponsorship API enables users to obtain gas estimates and gas sponsorship authentication signatures in accordance with a developer-defined policy. Users can then include the authentication signature provided by the sponsorship API with their transactions or user operations when submitting transactions or user operations. During on-chain execution, the gas policy management module contract validates the authentication signature prior to covering the gas fees for the associated transaction (or user operation). If signature validation fails, the gas policy management module contract reverts the operation, preventing unauthorized gas sponsorship.

FIG. 1 is a flowchart illustrating the elements of quickly and efficiently creating an off-chain gas sponsorship policy via an off-chain sponsorship API, supported and managed by a blockchain infrastructure provider (such as Alchemy). The off-chain gas sponsorship policy can be implemented using the ERC-4337 Verifying Paymaster which is a type of smart contract defined in the ERC-4337 standard. An ERC-4337 Verifying Paymaster can sponsor gas fees for users and verify user operations before they are executed. In contrast to the ERC-4337 Verifying Paymaster, off-chain gas management refers to a strategy or a set of rules for managing transactions off of the main chain. It is a concept or approach, not a specific smart contract or entity. The strategy or set of rules for managing transactions off the main chain govern how and when an application will sponsor a users' gas fees using the off-chain sponsorship API process.

The ERC-4337 Verifying Paymaster can implement an off-chain gas sponsorship policy. The ERC-4337 Verifying Paymaster contract serves as the on-chain enforcement mechanism that primarily validates the authorization signature provided by the off-chain policy engine and checks that the signature has not expired. The majority of sponsorship conditions and eligibility criteria are evaluated and enforced by the off-chain policy engine, which generates the authorization signature only when all policy requirements are satisfied. This architecture separates complex policy logic from on-chain validation, enabling flexible sponsorship rules while maintaining efficient verification.

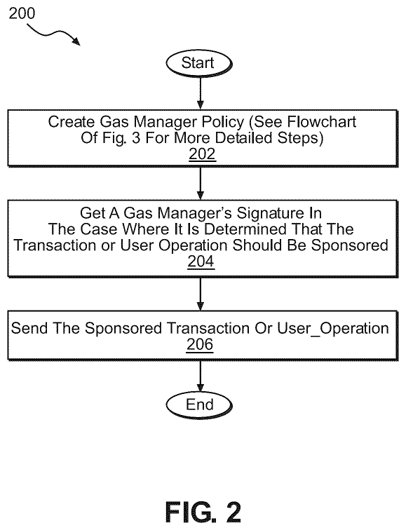

FIG. 2 illustrates a flowchart of the off-chain sponsorship API. This flowchart demonstrates the operational sequence and decision points that occur when the sponsorship API receives and processes sponsorship requests from developers. The process flow shows how the system evaluates incoming requests, applies policy rules, generates authentication signatures, and manages the overall API workflow from initial request through final response, providing a comprehensive view of the sponsorship API's functional operations.

Referring now to FIG. 2: At step 202, an off-chain gas sponsorship policy is created by the off-chain sponsorship API. The off-chain gas sponsorship policy is a comprehensive set of rules that define which user operations are eligible for gas sponsorship. These policy rules, which will be detailed in the subsequent steps, specify the criteria that determine when a developer will cover gas fees for their users' blockchain transactions, including spending limits, operational constraints, and eligibility requirements. At step 204, during the operational stage, the sponsorship API is responsible for determining if a requested transaction (or user operation) should be sponsored according to a developer's off-chain gas sponsorship policy. If the sponsorship API determines that the requested user operation should be sponsored, the sponsorship API is responsible for generating an authentication signature. Once it is determined that requested user operation should be sponsored according to the developer's off-chain gas sponsorship policy, the paymasterAndData field in the userOp object may be specified upon sending a user operation from a developer. This field is the signature of the off-chain gas sponsorship policy that validates the developer's sponsorship for the transaction (or user operation). A developer can get this field through alchemy_requestGasAndPaymasterAndData using the developer gas policy ID and a userOperation. The off-chain gas sponsorship policy signature will be generated by the sponsorship API if and only the userOperation satisfies the rules defined in the previously created gas policy at step 202. Notably, off-chain sponsorship API requests must be made with the API key associated with the developer's transaction gas sponsorship policy's application.

At step 206, once the developer obtains the paymasterAndData from the sponsorship API, the developer provides the data to the user. The user then incorporates the paymasterAndData into their userOperation and submits it directly through a separate submission API by calling eth_sendUserOperation. The on-chain gas sponsorship policy will pay for the gas of the userOperation when it is mined.

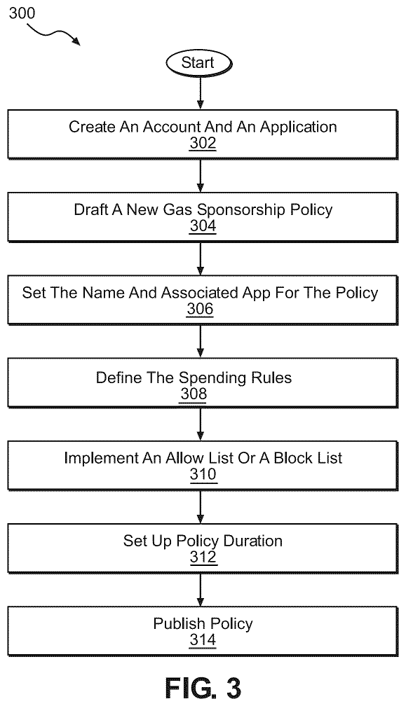

FIG. 3 illustrates a flowchart detailing the step-by-step process for creating an off-chain gas sponsorship policy in accordance with the sponsorship API process of FIG. 2. This flowchart breaks down the sequential steps and decision points that developers must navigate to establish a gas sponsorship policy, from initial policy initiation through final deployment. The process flow demonstrates the logical progression of policy creation activities, including configuration requirements, validation checkpoints, and completion criteria necessary to successfully implement a functional gas sponsorship policy within the sponsorship API system.

Referring now to FIG. 3. At Step 302: A developer may start by creating a new application or use an existing application and the associated chain.

At Step 304: With reference to the Figures below, this step requires the developer to Log in and navigate to the “Gas Policies” section and click create a policy button.

At Step 306: The Name for the Gas Policy is created and set in the App the developer wants to associate with the Gas Policy. A Gas Policy can only be associated with one App and it will only accept requests sent through the API key of the associated app. All other requests will be rejected.

At Step 308: The spending rules help limit the amount of money or the number of transactions (or user operations) that can be sent, enter the Name for the developer Gas Policy and set the App the developer wants to associate with it. A Gas Policy can only be associated with one App and it will only accept requests sent through the API key of the associated app. All other requests will be rejected.

At Step 310: an address allowlist or blocklist can be set up to allow the usage of the off-chain gas sponsorship policy to a list of specific addresses, or to exclude a list of certain addresses from the policy.

Step 312: the developer can define the duration of the developer's policy, and the sponsorship expiry period, which is the period for which the off-chain gas sponsorship policy signature will remain valid once it is generated.

Step 314: when the Gas Policy is ready, publish it. The policy becomes live if its date range includes the current time.

A developer may use the published Gas Policy to sponsor transactions (or user operations), comprising the following steps (1) retrieving the Gas Policy ID and getting supported entry points; (2) for each transaction (or user operation) requiring an off-chain gas sponsorship policy, (a) calling alchemy_requestGasAndPaymasterAndData or alchemy_requestPaymasterAndData with the transaction (or user operation) details. Satisfying (1) and (2) results in the off-chain gas sponsorship policy covering the gas fee for the submitted operation.

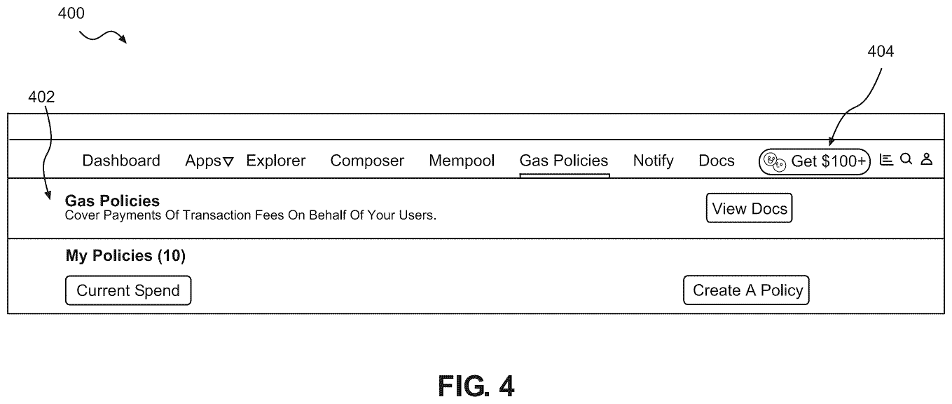

FIGS. 4-9 illustrate a comprehensive series of user interface screenshots that demonstrate the practical implementation of the off-chain gas sponsorship policy creation process described in FIGS. 2 and 3. These figures illustrate the actual dashboard interfaces, configuration screens, and workflow steps that developers encounter when establishing gas sponsorship policies through the sponsorship API system. The sequence of screenshots shows the complete end-to-end process from initial policy setup through final deployment, providing concrete visual examples of how the theoretical policy creation framework is translated into a user-friendly interface for practical application by developers seeking to sponsor their users' gas fees.

FIG. 4 depicts a gas policy management dashboard interface 400 showing the main navigation and policy overview. The interface displays a “Gas Policies” section 402 with options to view current policies and create new policies. The dashboard includes navigation tabs for Dashboard, Apps, Explorer, Composer, Mempool, Gas Policies, Notify, and Docs, with a gas balance indicator 404 showing “Gas $100” in the upper right corner.

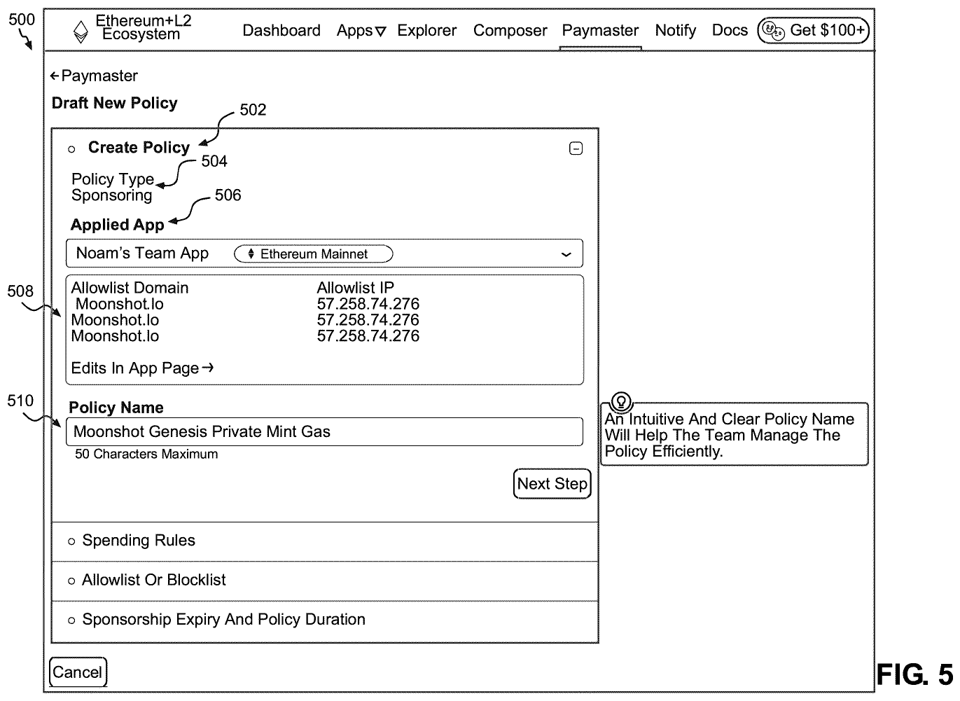

FIG. 5 illustrates a “Draft New Policy” interface 500 for creating a gas sponsorship policy. The interface shows a policy creation workflow with sections for “Create Policy” configuration 502, including policy type selection for “Sponsoring” 504 and an “Applied App” field 506 showing “Noam's Team App” with Ethereum Mainnet selection. The interface also displays wallet domain information 508 with multiple Ethereum addresses (0x2b4 . . . 4c278, 0x7d9 . . . 4c278, etc.) and includes fields for policy naming 510, with “Moonshot Genesis Private Mint Gas” shown as an example policy name.

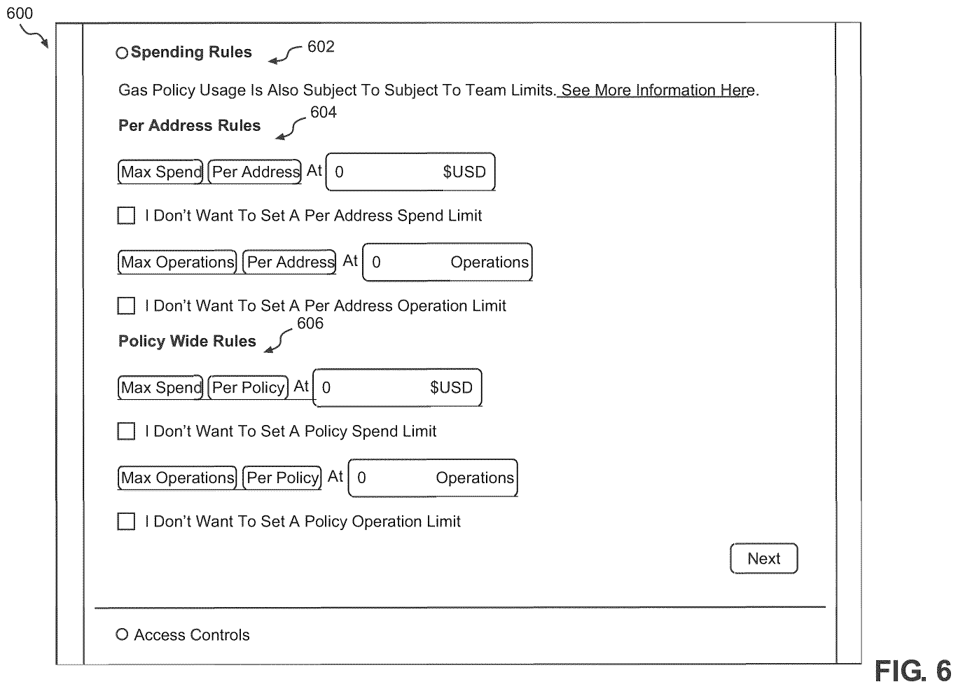

FIG. 6 shows the spending rules configuration interface 600 for gas policy management. The interface displays “Spending Rules” 602 with options for “Gas Policy Usage By Max Subject To Subject To Team Limits.” The interface further displays “Per Address Rules” 604 with fields for maximum spend limits per address. The interface also shows policy-wide spending rules, i.e., “Policy Wide Rules” 606 with maximum spend and operation limits, along with checkboxes for setting per-address and per-policy spend limits.

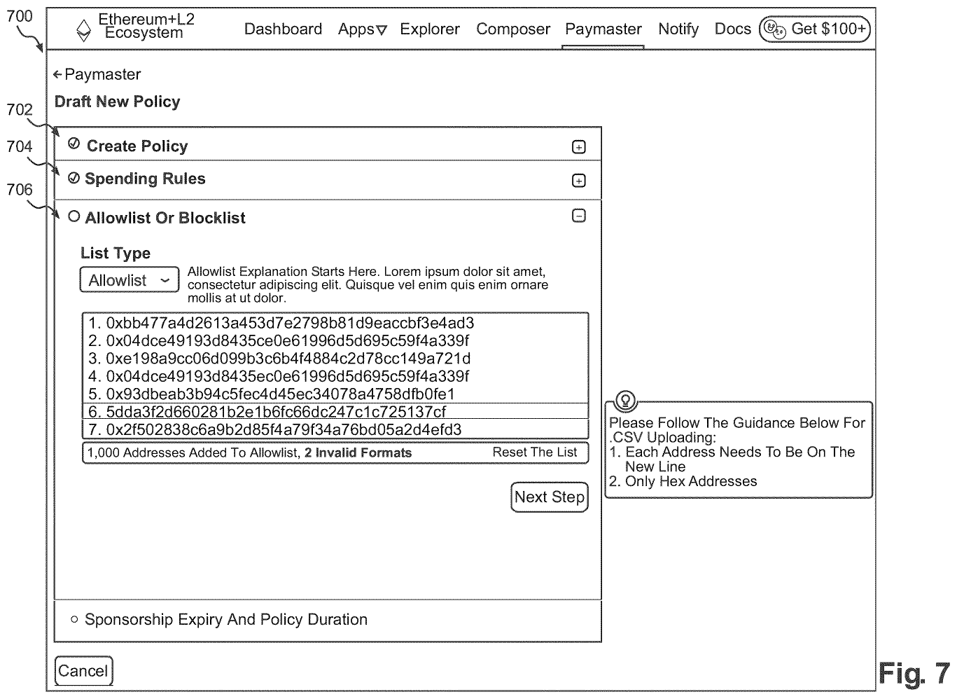

FIG. 7 presents an allowlist/blocklist configuration interface 700 showing expandable sections for “Create Policy,” “Spending Rules,” and “Allowlist Or Blocklist.” The interface displays a list of Ethereum addresses in a scrollable format with options to manage allowed addresses. The interface includes guidance text indicating “Follow The Guidance Below For CSV Uploading” and shows multiple Ethereum addresses in the allowlist configuration.

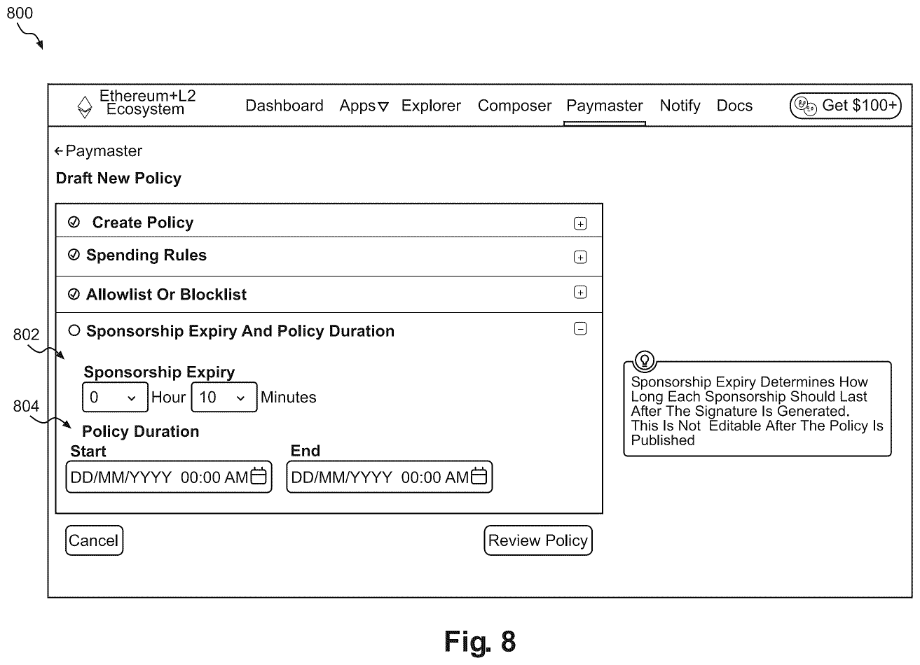

FIG. 8 depicts the sponsorship expiry and policy duration configuration interface 800. The interface shows settings for “Sponsorship Expiry” 802 with time duration controls (hours and minutes), and “Policy Duration” 804 with start and end date fields showing MM/DD/YYYY format placeholders. The interface includes explanatory text about sponsorship expiry duration and policy timeframes.

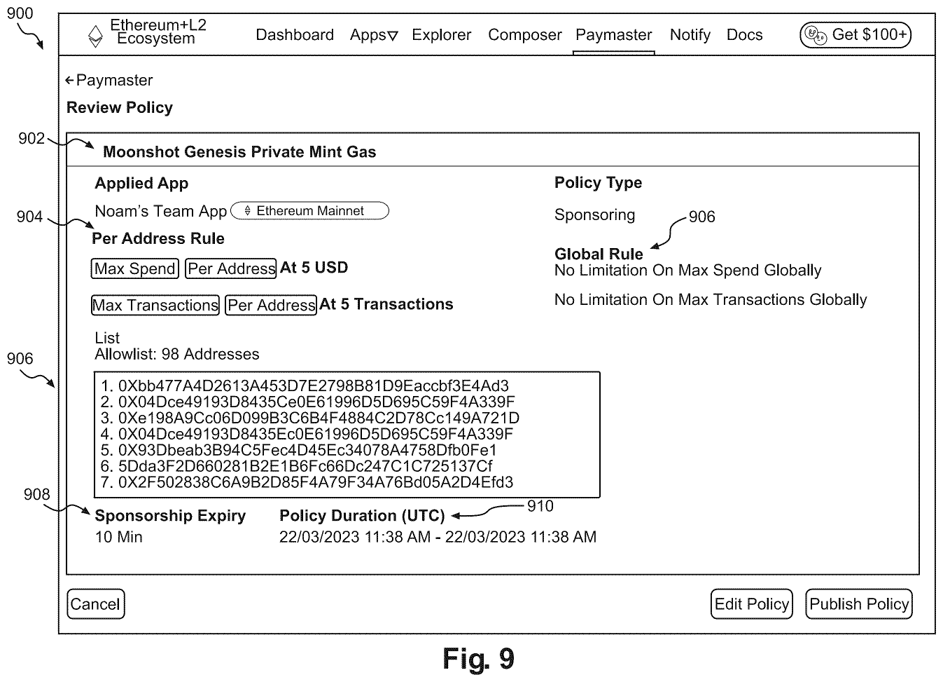

FIG. 9 illustrates the policy review interface displaying a completed gas policy configuration 900. The interface shows “Moonshot Genesis Private Mint Gas” 902 as the policy name, applied to “Noam's Team App” on Ethereum Mainnet. The interface displays configured spending rules (i.e, Per Address Rule 904), global rules 906, allowlist addresses 906 (showing multiple Ethereum addresses), sponsorship expiry settings 908 (e.g., 10 Min), and policy duration 910 with specific start and end timestamps. The interface includes options to edit the policy or publish the policy for deployment.

### AI EXAMPLE EMBODIMENTS

The gas sponsorship system 100 described herein may be enhanced through the integration of artificial intelligence and machine learning capabilities to provide adaptive, intelligent management of sponsorship policies and fraud detection. While the foundational three-phase operation (Initial Request Processing Phase, Policy Evaluation and Authorization Phase, and Blockchain Monitoring and Settlement Phase) provides robust policy enforcement and transaction management, the addition of AI-driven modules enables dynamic optimization of resource allocation, predictive analysis of user behavior, and automated detection of malicious activities. These AI embodiments leverage the existing system architecture components including the Policy Engine 110, Sponsorship Database 114, and Blockchain Data Access module 120 to create intelligent feedback loops that continuously improve sponsorship decision-making, protect against fraudulent transactions, and optimize operational efficiency. The following AI embodiments demonstrate how machine learning algorithms can be integrated into the gas sponsorship system 100 to provide enhanced functionality that adapts to changing user patterns, market conditions, and security threats while maintaining the core policy enforcement and cryptographic authorization capabilities of the underlying system.

### AI Example Embodiment (1)—Dynamic Fund Allocation Based on User Revenue Potential

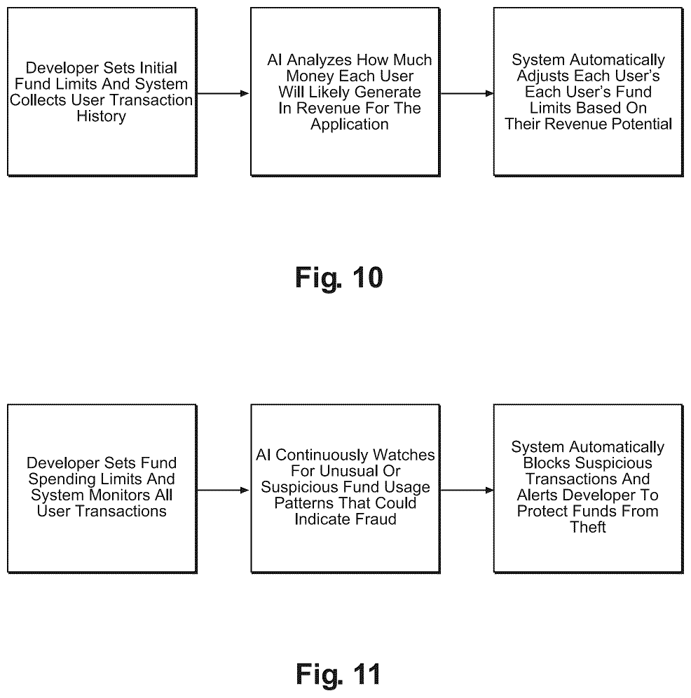

Referring to FIG. 10, a developer may implement a computing system with machine learning capabilities that executes a dynamic fund allocation system. The system categorizes users based on their revenue potential to the application by analyzing user behavioral patterns and transaction data. An adaptive learning module analyzes user data and blockchain activity over time to predict each user's future revenue generation capability. In response to this analysis, automated algorithms assign appropriate fund limits that correspond to the user's predicted revenue potential, optimizing resource allocation while maximizing application profitability.

A process for carrying out this functionality may involve computational steps executed by machine learning algorithms on distributed processing systems:

Inputs: Fund limit parameters that the developer wants to establish based on different revenue potential categories stored as structured data vectors in indexed database systems. User wallet addresses for identification and tracking processed through cryptographic hash functions and stored in blockchain monitoring databases with real-time synchronization protocols.

Training: The machine learning system learns from historical user data over time by analyzing structured datasets containing transaction patterns, usage frequency, and their associated revenue contributions to the application. The AI system analyzes correlations between specific blockchain activities and behavioral patterns to predict future revenue potential, creating predictive models for user categorization that execute on specialized computing hardware.

Outputs: Machine-generated dynamic fund allocation commands transmitted through secure API interfaces, creating dynamic fund limits that correspond to each user's predicted revenue potential category computed through classification algorithms outputting categorical probability distributions. Users with higher revenue potential receive access to larger fund allocations through automated database updates executed by fund allocation processing modules, while those with lower predicted revenue are assigned more conservative limits via programmatic enforcement mechanisms implemented through smart contract interaction protocols.

This AI-driven algorithmic system executing on distributed computing infrastructure allows the developer to automatically optimize fund distribution by intelligently categorizing users through machine learning classification algorithms processing multi-dimensional behavioral data sets based on their potential value to the application. The system implements real-time monitoring processes that execute statistical analysis algorithms on streaming blockchain data to ensure that high-value users have sufficient resources to maximize their contributions while protecting against excessive resource allocation to lower-value users through automated threshold enforcement algorithms and anomaly detection systems, thereby optimizing overall application profitability and resource utilization via computational optimization processes executing continuous resource rebalancing algorithms on specialized hardware infrastructure.

The technical solution addresses the computational challenge of real-time user behavior analysis and predictive resource allocation in blockchain-based applications, requiring specialized algorithms to process high-volume transaction streams, extract semantic features from smart contract interactions, execute multi-dimensional classification operations on user behavioral patterns, and maintain sub-second response times for dynamic fund allocation decisions across distributed computing networks while ensuring data consistency and security through cryptographic verification protocols.

### AI Example Embodiment (2)—Set Limits on Funds a User is Authorized to Use

Referring to FIG. 11, a developer may set limits (parameters) on the funds a user is authorized to access. An adaptive learning module implements safeguards to protect the funds from malicious activity using adaptive learning techniques with real-time monitoring capabilities. A process for carrying out this functionality may include steps of:

Inputs: Setting Fund Limit Parameters—The developer can set specific parameters that define multiple types of fund access limits including: (1) daily spending limits, (2) per-transaction limits, and (3) total balance limits. The developer can also configure the confidence level at which malicious activity is flagged, allowing customization of detection sensitivity to match their application's risk profile (e.g., gaming apps can set more relaxed thresholds than financial apps). Additionally, the developer can maintain an allowlist of addresses of known users that can bypass the entire malicious activity system.

Training: Malicious Activity Detection-Using adaptive learning techniques, the adaptive learning module monitors and analyzes patterns of fund depletion in real-time. The system generates a normal “average” pattern baseline that it uses to classify all users initially. Users start with that baseline level, and their behavior is updated from that point-they are able to access more funds without anomaly detection as they build up a larger history of high usage with the application. For new users with no historical fund usage data, the baseline is an average user profile, and if the maximum limit is well above what a new user typically spends, this would be flagged as potential malicious activity. The system is trained to recognize multiple behavioral patterns including: spending velocity (e.g., a user who normally spends $10/day but suddenly attempts to spend their entire $1000 limit in one transaction), transaction frequency (e.g., a user suddenly making 50 transactions per minute when they normally make 5 per day), and unusual usage amounts. The model is retrained once a day based on data from that day, ensuring that new attack patterns emerging on one day will be adapted to by the next day. The system operates as real-time monitoring, detecting suspicious fund depletion patterns within seconds.

Outputs: Safeguard Implementation-Upon detecting suspicious patterns via the adaptive learning module output, the system triggers configurable safeguards to prevent further depletion of funds. The system can be configured to operate in two modes: “fail open” configuration where it alerts the developer of potential malicious activity and requires a human to freeze the account, or “fail close” configuration where it freezes the account immediately upon detection. The system can implement graduated restrictions rather than complete blocking, such as reducing daily limits from $100 to $20 instead of completely freezing the account. These safeguards include:
Real-time Monitoring: Constantly monitoring transactions or operations related to fund usage with detection and response within seconds.
Anomaly Detection: Identifying deviations from normal user behavior based on spending velocity, transaction frequency, and unusual usage amounts.
Automated Blocking: Implementing automatic blocks or restrictions on transactions that are flagged as potentially malicious (when configured in “fail close” mode).
Alert Mechanisms: Notifying developers about detected malicious activities for further action (particularly in “fail open” mode).
Recovery Process: When funds are blocked due to suspected malicious activity, users must reach out to the developer's support team, and the developer must manually restore their access. The developer can implement a two factor authentication mechanism if they wish to automate this process via the system's APIs.
Developer Override Capabilities: Developers can override or adjust fund limits and detection parameters for specific users or situations, such as manually increasing limits for a VIP user or temporarily disabling malicious activity detection during a promotional event.

Preserving Funds for Authorized Use-By promptly identifying and blocking malicious activities through adaptive learning, the developer ensures that funds are safeguarded and only accessible for legitimate and authorized purposes. The maximum limits remain static until manually changed by the developer.

In sum, a developer may leverage adaptive learning to dynamically adapt and enhance the system's ability to detect and mitigate malicious fund depletion activities in real-time. This proactive approach helps maintain the integrity and security of the funds, preventing unauthorized access and usage effectively while providing configurable sensitivity levels and response mechanisms to match different application risk profiles.

### AI Example Embodiment (3)—Sponsoring Certain Types of User Operations

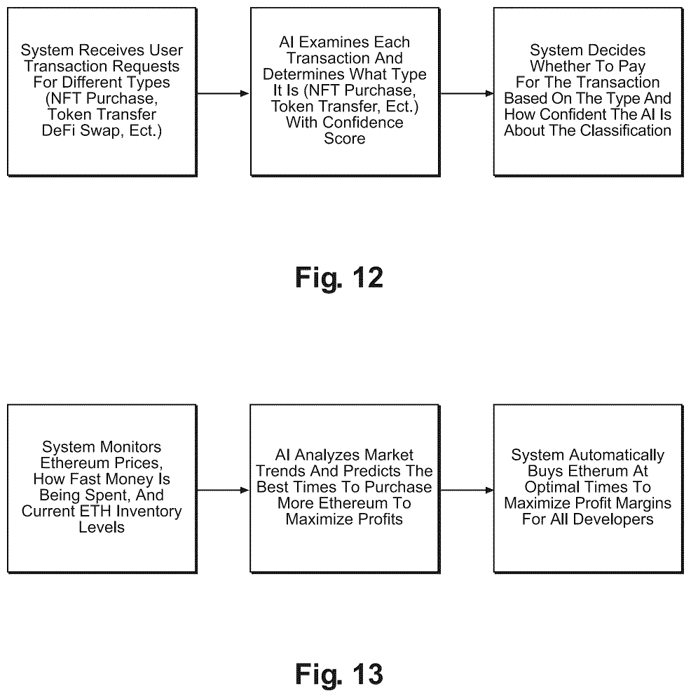

Referring now to FIG. 12, in this exemplary embodiment, a developer may implement a specialized computing system comprising machine learning processing units, blockchain interface modules, and confidence scoring algorithms that enables selective sponsorship of certain types of transactions. The system categorizes transaction types through automated classification algorithms and applies configurable confidence thresholds to determine sponsorship decisions, executing on dedicated hardware infrastructure.

Inputs: labeled transaction data received through blockchain monitoring APIs and processed by data preprocessing modules into structured feature vectors categorized by type, including but not limited to token transfers, decentralized finance (DeFi) protocol interactions (such as swaps, deposits, loans, and claims), decentralized autonomous organization (DAO) votes, contract deployments, asset registration, and non-fungible token (NFT) purchases stored in indexed database structures with cryptographic hash verification.

Training: a machine learning system implementing deep neural networks with attention mechanisms and transformer architectures learns to identify and categorize new transactions across multiple predefined operation types through computational analysis of blockchain transaction bytecode, smart contract function signatures, and parameter encoding patterns. The system can be enhanced with custom labels for specific smart contracts provided by developers, enabling accurate identification of interactions with application-specific contracts through feature engineering algorithms that extract semantic patterns from contract execution traces, though the system does not learn entirely new operation categories outside the predefined neural network output layer classifications.

Outputs: Machine-readable classification vectors containing one or more label types for a user's operation along with associated confidence scores generated by softmax probability distributions computed by the neural network's output layer that policy engines implemented as rule-based computational systems can utilize for sponsorship decisions. When an operation falls into multiple categories, it becomes eligible for sponsorship under policies corresponding to each applicable category type through multi-label classification algorithms that process overlapping probability distributions.

The system implements configurable confidence thresholds that policy makers can adjust based on their tolerance for potential false positives versus false negatives. The system compares confidence scores against stored threshold values to balance the risk of sponsoring unintended operations against the risk of blocking legitimate user activities, with the specific threshold settings determined by the properties and requirements of their applications and implemented through automated decision processes executing on computing hardware.

As one example, the developer may only want to sponsor non-fungible token (NFT) purchases. The AI system, comprising neural networks and transformer architectures trained on NFT transaction patterns, labels a transaction with its likelihood of being an NFT purchase along with a confidence score computed through forward propagation algorithms processing transaction feature vectors. Based on both the likelihood classification and whether the confidence score meets the configured threshold through automated comparison operations executed by arithmetic logic units, the system will determine whether to sponsor the operation or not by generating machine-executable sponsorship authorization signals transmitted through secure API interfaces.

### AI Example Embodiment (4)—Optimize Time to Purchase ETH for Sponsorship

Referring now to FIG. 13, in this exemplary embodiment, a developer may implement a distributed computing system comprising specialized processing units, market data processing modules, and automated execution interfaces that learns the best time to purchase ETH for sponsorship across multiple developers through machine learning algorithms executing on dedicated hardware. As part of this system, the Gas Manager server system purchases ETH from a shared pool so that developers only need to spend US dollars, while the Gas Manager handles all ETH procurement and management through automated API interfaces with cryptocurrency exchanges. The gas manager implements time-series prediction models executing on specialized forecasting hardware to determine the optimal timing for ETH purchases that maximize margin across all sponsored operations by analyzing market conditions and demand patterns.

Inputs: ETH market data received through real-time data feeds and processed by specialized data ingestion modules, historical and real-time spend rate data across all developer policies stored in distributed databases with indexed access patterns, current ETH inventory levels tracked through blockchain monitoring services, and forecasted sponsorship demand patterns generated by neural network prediction algorithms.

Training: The machine learning system, comprising neural network architectures with temporal attention mechanisms, adaptively learns the optimal timing for ETH purchases by computationally analyzing multi-dimensional data vectors representing spend rates of the sponsorship system and ensuring continuous ETH availability through algorithmic inventory management processes. The prediction horizon dynamically adjusts based on computational forecasting models that process blockchain transaction data and market volatility indicators to determine ETH depletion timing, with the AI executing optimization algorithms on parallel processing units within the calculated timeframe before the system would run out of ETH. The deep learning algorithm processes feature vectors encoding varying demand patterns across multiple developers and their respective sponsorship policies through convolutional and recurrent neural network layers.

Outputs: Machine-readable ETH purchase execution signals with programmatically-generated API calls to cryptocurrency exchanges, automated database updates to inventory management systems, and algorithmic trigger conditions stored in computer memory that ensure optimal acquisition timing while maintaining sufficient ETH reserves to serve all sponsorship needs without interruption through real-time computational monitoring and control systems.

The Gas Manager server infrastructure operates a shared ETH pool that serves all developers simultaneously, eliminating the need for individual ETH management and enabling bulk purchase efficiencies through centralized computational resource allocation. When developers utilize the sponsorship system, they are charged based on the current market price of ETH at the time of sponsorship through automated billing calculation modules executing pricing algorithms, while the Gas Manager's margin is calculated by computational processes that analyze historical cost data stored in relational databases as the difference between the historical acquisition cost of the ETH used and the revenue recognized from charging developers at current market rates.

This approach allows the Gas Manager computing system to optimize purchase timing through execution of multi-objective optimization algorithms on specialized hardware to minimize acquisition costs while charging developers at current market rates, creating margin opportunities through algorithmic timing optimization of cryptocurrency acquisition processes. The system ensures that conflicting timing needs across multiple developers are resolved through computational resource scheduling algorithms managing the shared pool approach, where ETH is purchased through automated execution of purchase orders generated by machine learning prediction systems to serve all developer policies collectively rather than optimizing for individual developer requirements.

### AI Example Embodiment (5)—Adaptive Learning-Based Alerting

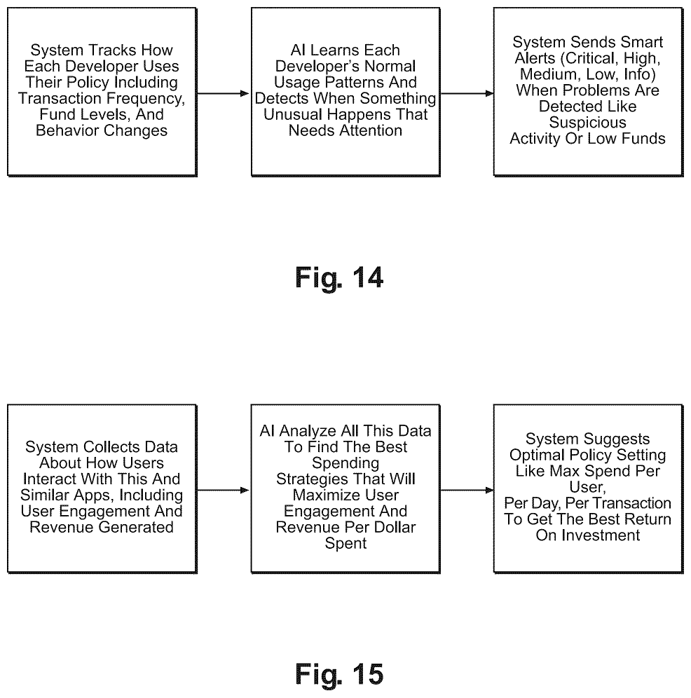

Referring now to FIG. 14, in this exemplary embodiment, a developer may implement a distributed computing system comprising machine learning processing units, real-time monitoring modules, and alert generation engines that can be trained on usage patterns of a particular developer's policy to determine when to alert that user for various events that require developer interaction. The system uses automated pattern recognition algorithms executing on specialized hardware to analyze usage patterns and behavioral indicators, processing signals indicating malicious activity, high usage alerts, and low fund alerts. The system provides estimates as to when funds will deplete based on predictive modeling algorithms that analyze historical consumption data and classify alerts by severity levels.

Inputs: Usage pattern data streams received through API monitoring interfaces and processed into structured feature vectors representing a particular developer's policy including transaction frequency patterns, resource consumption metrics, funding level time-series data, and behavioral anomaly indicators stored in indexed database structures.

Training: Machine learning algorithms implementing neural network architectures with temporal sequence processing capabilities train on computational analysis of input usage patterns of a particular developer's policy to determine when to alert that user for various issues that require developer interaction. The system implements a cold-start solution utilizing ensemble learning algorithms that initialize new developer policies with averaged alert parameters computed from aggregated training data across all existing developer policies, then adapts through personalized learning algorithms as policy-specific data accumulates. Alert classification algorithms process pre-labeled malicious behavior datasets to train pattern recognition models, while supervised learning mechanisms incorporate developer feedback through false positive labeling interfaces that update model parameters during subsequent training cycles.

Outputs: Machine-generated alert notifications transmitted through programmatic communication interfaces, categorized by algorithmic severity classification systems that alert users for various events that require developer interaction. The alert generation system implements five-tier severity levels (critical, high, medium, low, informational) processed by priority classification algorithms, with alerts of equivalent severity handled through equal-weight queuing mechanisms executed by specialized alert processing hardware. Developer subscription management systems allow selective alert filtering based on computational severity thresholds, with programmable alert silencing capabilities implemented through configurable rule engines.

The system addresses the technical challenge of real-time anomaly detection in high-volume transaction processing environments, requiring specialized algorithms to analyze multi-dimensional usage patterns, detect statistical deviations from baseline behavior models, and generate contextually-appropriate alerts while maintaining sub-second processing latencies across distributed computing infrastructure.

For fund depletion predictions, the system implements time-series forecasting algorithms executing on dedicated computing resources, processing historical spending data to generate estimates of when funds will run out with confidence intervals. The system analyzes patterns in how quickly funds have been consumed in the past to predict future spending rates. This allows developers to receive advance warning before their sponsored fund pools become exhausted, enabling proactive fund management decisions.

Malicious activity detection utilizes machine learning classification algorithms trained on datasets of known attack patterns, analyzing transaction data, timing patterns, and behavioral signatures to distinguish between legitimate unusual activity and malicious behavior through automated scoring mechanisms. The system learns to recognize suspicious patterns such as unusually rapid fund depletion, abnormal transaction frequencies, or behavior that deviates significantly from a user's established patterns. When potential malicious activity is detected, the system can automatically implement protective measures to prevent unauthorized fund access.

The false positive reduction system implements learning algorithms that incorporate developer feedback through user interface mechanisms, updating classification models and retraining parameters to improve future alert accuracy based on corrected examples stored in feedback databases. When developers mark alerts as false positives, the system learns from these corrections to avoid similar mistakes in the future. This continuous learning process helps the system become more accurate over time, reducing unnecessary alerts while maintaining effective protection against genuine threats.

### AI Example Embodiment (6)—Policy Recommendation System

Referring now to FIG. 15, in this exemplary embodiment, a distributed computing system comprising machine learning optimization engines, real-time analytics processing units, and policy generation modules is trained to make recommendations to policy settings based on the types of transactions (or user operations) a developer is trying to sponsor through computational analysis of multi-protocol interaction datasets and revenue optimization algorithms. The system implements multi-objective optimization algorithms executing on specialized hardware that can also make recommendations on policy total spend based on marketing needs by processing engagement metrics and revenue attribution calculations through predictive modeling algorithms.

Inputs: Market data for transactions (or user operations) comprising structured datasets containing historical interaction records from the developer's protocol and all similar protocols, processed through data aggregation algorithms and stored in distributed databases with indexed access patterns. The system ingests real-time transaction streams, user engagement metrics calculated through behavioral analysis algorithms, protocol fee revenue data processed by financial computation modules, and competitive analysis datasets generated through blockchain monitoring APIs.

Training: Machine learning algorithms implementing neural network architectures with multi-objective optimization capabilities are trained to make recommendations to policy settings based on the types of transactions (or user operations) a developer is trying to sponsor through computational analysis of historical engagement patterns and revenue correlation algorithms. The system utilizes reinforcement learning algorithms with reward functions optimized for user engagement maximization and protocol fee revenue optimization, processing feature vectors that encode transaction (or user operation) types, spending patterns, user behavior sequences, and competitive protocol performance metrics through deep learning models executing on dedicated AI acceleration hardware.

Outputs: Machine-generated policy recommendation vectors transmitted through programmatic API interfaces, including policy recommendations for: (1) max spend per user calculated through user lifetime value prediction algorithms, (2) max spend per transaction or user operation determined by cost-benefit optimization models, (3) max spend per day computed through budget allocation algorithms and engagement forecasting models, and additional policy parameters generated through multi-dimensional optimization processes executing on parallel computing infrastructure.

The system calculates engagement scores from user interaction data including session duration, transaction frequency, and retention rates. Revenue optimization algorithms forecast protocol fee generation based on sponsorship spending patterns, with the objective of maximizing engagement and revenue per sponsorship dollar spent.

The system analyzes interaction patterns from similar protocols through blockchain monitoring, processing transaction data and smart contract interactions to identify optimal sponsorship strategies.

Policy recommendations are generated using machine learning algorithms that combine multiple models to produce optimal policy settings while ensuring recommended policies comply with budget limitations and maximize user engagement and protocol revenue.

### INSTRUCTIONAL EXAMPLES

To illustrate the operational capabilities and practical applications of the disclosed off-chain gas management system, the following examples demonstrate how the three-phase system architecture processes sponsorship requests for different use cases. These instructional examples show the system's flexibility in supporting various blockchain application requirements.

### Example 1: DeFi Swap Promotion

A DeFi token swapping application wants to run a promotion that gives each user up to 5 token swaps with free gas (up to $1 USD per user operation). This promotion will end in 1 month. In other words, A blockchain-based currency exchange platform is running a month-long marketing promotion that eliminates gas fees for users' first 5 trades, with the company paying up to $1 in network fees per user operation

### Parties:

Developer/Policy Owner: The entity operating the DeFi token swapping application who creates and funds the gas sponsorship policy through the gas policy management module sponsorship API quickstart.
End User: Individual users of the DeFi application who benefit from sponsored gas fees, interacting through the User/Client component.
dApp/Frontend 102: The DeFi frontend interface through which users interact with the token swapping protocol
Gas Sponsorship System 100: Comprising the API Gateway 104, Sponsorship Service 106, Policy Engine 110, Key Manager 108, and associated databases, collectively managing policy enforcement and cryptographic signing
ERC-4337 Verifying Paymaster: The on-chain contract that validates signatures and pays gas fees, implementing the off-chain gas sponsorship policy.

### Policy Creation Process:

The developer creates a policy through the gas policy management module sponsorship API process 110. (See FIG. 2—detailed steps for creating an off-chain gas sponsorship policy created in accordance with the off-chain sponsorship API process).
1. Create an account and application within the gas sponsorship system 100.
2. Navigate to the “Gas Policies” section via the API Gateway 104.
3. Configure policy rules that will be stored in the Policy Database 112 and enforced by the Policy Engine 110.
4. Obtain the private policy ID for use with the sponsorship APIs (the programmatic interfaces accessible through the alchemy_requestGasAndPaymasterAndData endpoint.

### Policy Configuration Process:

The policy, stored in the Policy database 112, enforces the following rules under control of the Policy Engine Module 110:
Maximum sponsorship value per user operation: $1 USD. The maximum cost calculation involves the Gas Estimation and Gas Fee Estimation functions performed by the sponsoring gas manager module. The system converts from the network's native token to USD using real-time pricing data accessed through the Blockchain Data Access module 120.
Maximum number of user operations per sender: 5 user operations per wallet address. Giving a user 5 token swaps with free gas means the Policy Engine 110 tracks sponsorship history in the Sponsorship Database 114 to ensure each wallet address receives coverage for exactly five token exchange user operations, removing financial barriers for users.
Policy duration: 1 month. The policy expiry time is enforced both off-chain by the Policy Engine (110) during the Policy Evaluation and Authorization Phase and on-chain by the ERC-4337 Verifying Paymaster contract during user execution.
Contract allowlist: The Policy Engine 110 maintains an allowlist of approved smart contract addresses (the developer's token swapping contracts) in the Policy Database 112, ensuring sponsorship only applies to intended DeFi operations.

### Sponsorship Request Workflow:

### Sponsorship Request Workflow (Three-Phase System Operation for DeFi Token Swap):

Initial Request Processing Phase: When a user clicks “swap tokens” on the DeFi token swapping application's frontend 102, intending to exchange one cryptocurrency for another, the DeFi application automatically generates a user operation containing the swap transaction details (target token contracts, swap amounts, user's wallet address). The DeFi application then sends this token swap operation to the alchemyrequestGasAndPaymasterAndData endpoint 102 requesting gas sponsorship for the swap transaction. This sponsorship request is routed through the API Gateway 104 for load balancing and validation, then forwarded to the Central Sponsorship Service 106 which begins evaluating whether this specific token swap qualifies for sponsored gas under the promotion policy.

### Policy Evaluation and Authorization Phase:

The Sponsorship Service 106 queries the Policy Engine 110 specifically asking: “Should we sponsor gas for this user's token swap?” The Policy Engine 110 retrieves the DeFi promotion policy from the Policy Database 112 and checks the user's swap history from the Sponsorship Database 114, verifying:
(1) this user has performed fewer than 5 previous swaps,
(2) the estimated gas cost is under $1 USD,
(3) the swap targets the approved DeFi contract addresses, and
(4) the promotion period hasn't expired. Upon confirming this token swap meets all promotion criteria, the Key Manager 108 generates a cryptographic signature authorizing gas sponsorship specifically for this user's token swap transaction. The signed authorization for the token swap is returned to the DeFi application and stored in the Sponsorship Database 114 with “pending” status, indicating a token swap is awaiting execution.

### Blockchain Monitoring and Settlement Phase:

The user receives the sponsored authorization from the DeFi application, signs the complete token swap transaction (or user operation) with their wallet, and submits it to the blockchain where the ERC-4337 Verifying Paymaster contract covers the gas fee. The Sponsorship Indexing service 116 monitors the Blockchain Data Access module 120 specifically watching for this user's token swap transaction (or user operation) to be confirmed on-chain. Upon detecting the successful completion of the sponsored token swap, the system updates the Sponsorship Database 114 to record that this user has now completed one of their five free swaps, and triggers the Billing Service 118 to charge the DeFi developer's account for the actual gas costs incurred during the token swap execution.

### On-Chain Validation:

The ERC-4337 Verifying Paymaster contract (implementing the off-chain gas sponsorship policy performs signature validation, timestamp verification, before covering gas fees, ensuring all policy rules are enforced at the blockchain level.

### Example 2: Social Media App Internalizes Gas Fees

A social media application wants to internalize all gas fees for users to provide a seamless Web3 experience without requiring users to manage such gas fees. The platform aims to cover the cost of all onchain actions taken by users within their app, eliminating the need for users to hold native gas tokens or understand gas concepts. The application will treat gas sponsorship as an operational expense and expects to offset these costs through advertising revenue, premium subscriptions, and user engagement monetization.

### Parties to the Transaction:

Developer/Policy Owner: The entity operating the social media application who creates and maintains the comprehensive gas sponsorship policy through the gas policy management module sponsorship API quickstart, funding all user gas fees
End User: Individual users of the social media platform who benefit from completely sponsored gas fees for all interactions including posting content, reactions, social tokens, and NFT purchases, interacting through the User/Client component.
dApp/Frontend 102: The social media frontend interface through which users interact with blockchain-based social features including content publishing, social token transfers, and NFT minting.
Gas Sponsorship System 100: Comprising the API Gateway 104, Sponsorship Service 106, Policy Engine 110, Key Manager 108, and associated databases, collectively managing unlimited policy enforcement and cryptographic signing for all user operations
ERC-4337 Verifying Paymaster: The on-chain contract that validates signatures and pays gas fees for all user operations, implementing the comprehensive off-chain gas sponsorship policy.

### Policy Creation Process:

The developer creates a comprehensive sponsorship policy through the gas policy management module sponsorship API process 110. (See FIG. 2—detailed steps for creating an off-chain gas sponsorship policy created in accordance with the off-chain sponsorship API process).
1. Create an enterprise account and application within the gas sponsorship system 100 with elevated funding capabilities.
2. Navigate to the “Gas Policies” section via the API Gateway 104.
3. Configure unlimited sponsorship policy rules that will be stored in the Policy Database 112 and enforced by the Policy Engine 110.
4. Obtain the private policy ID for use with the sponsorship APIs (the programmatic interfaces accessible through the alchemy_requestGasAndPaymasterAndData endpoint.

### Policy Configuration Process:

The policy, stored in the Policy Database 112, enforces the following rules under control of the Policy Engine Module 110:
(1) Maximum sponsorship value per user operation: Unlimited. The system performs Gas Estimation and Gas Fee Estimation functions through the sponsoring gas manager module without imposing per-transaction limits, converting from the network's native token to USD using real-time pricing data accessed through the Blockchain Data Access module 120.
(2) Maximum number of user operations per sender: Unlimited operations per wallet address. The Policy Engine 110 tracks all sponsorship activity in the Sponsorship Database 114 but does not impose quantity restrictions, enabling unrestricted user engagement with social media features.
(3) Policy duration: Unlimited duration. The policy remains active indefinitely without expiry time enforcement, managed by the Policy Engine 110 during the Policy Evaluation and Authorization Phase and the ERC-4337 Verifying Paymaster contract during transaction or user operation execution.
(4) Contract allowlist: The Policy Engine 110 maintains a strict allowlist of approved smart contract addresses (exclusively the developer's social media platform contracts) in the Policy Database 112, ensuring sponsorship only applies to legitimate social media operations and preventing abuse through external contract interactions.
(5) IP allowlist: The Policy Engine 110 enforces IP address restrictions stored in the Policy Database 112, permitting sponsorship requests only from the social media application's backend infrastructure, preventing unauthorized third-party sponsorship requests and ensuring all transactions or user operations originate from the legitimate platform.

### Sponsorship Request Workflow:

### Sponsorship Request Workflow (Three-Phase System Operation for Social Media Interactions):

### Initial Request Processing Phase:

When a user performs any action within the social media application's frontend 102, such as posting content, liking posts, transferring social tokens, or minting NFTs, the social media application automatically generates a user operation containing the interaction details (target smart contracts, transaction parameters, user's wallet address). The social media application's backend then sends this user operation to the alchemy_requestGasAndPaymasterAndData endpoint 102 requesting gas sponsorship for the social interaction. This sponsorship request is routed through the API Gateway 104 for load balancing and validation, then forwarded to the Central Sponsorship Service 106 which begins evaluating whether this specific social media interaction qualifies for sponsored gas under the comprehensive coverage policy.

### Policy Evaluation and Authorization Phase:

The Sponsorship Service 106 queries the Policy Engine 110 specifically asking: “Should we sponsor gas for this user's social media interaction?” The Policy Engine 110 retrieves the social media comprehensive sponsorship policy from the Policy Database 112 and validates the request against stored criteria in the Sponsorship Database 114, verifying:
(1) the interaction targets approved social media contract addresses from the contract allowlist,
(2) the sponsorship request originates from an authorized IP address matching the social media backend infrastructure,
(3) the user operation represents a legitimate social media interaction (content posting, reactions, social token transfers, NFT operations), and
(4) the policy remains active with unlimited duration. Upon confirming this social media interaction meets all policy criteria, the Key Manager 108 generates a cryptographic signature authorizing gas sponsorship specifically for this user's social media interaction. The signed authorization for the social interaction is returned to the social media application and stored in the Sponsorship Database 114 with “pending” status, indicating a social media operation is awaiting execution.

### Blockchain Monitoring and Settlement Phase:

The user receives the sponsored authorization from the social media application, signs the complete social media transaction with their wallet, and submits it to the blockchain where the ERC-4337 Verifying Paymaster covers the gas fees. The Sponsorship Indexing service 116 monitors the Blockchain Data Access module 120 specifically watching for this user's social media transaction to be confirmed on-chain. Upon detecting the successful completion of the sponsored social interaction, the system updates the Sponsorship Database 114 to record the completed operation, and triggers the Billing Service 118 to charge the social media developer's account for the actual gas costs incurred during the social media transaction execution, treating these costs as operational expenses offset by platform revenue streams.

### On-Chain Validation:

The ERC-4337 Verifying Paymaster contract (implementing the off-chain gas sponsorship policy) performs signature validation, contract allowlist verification, and policy compliance checking before covering gas fees, ensuring all policy rules are enforced at the blockchain level while maintaining the seamless user experience that eliminates gas-related friction from social media interactions.

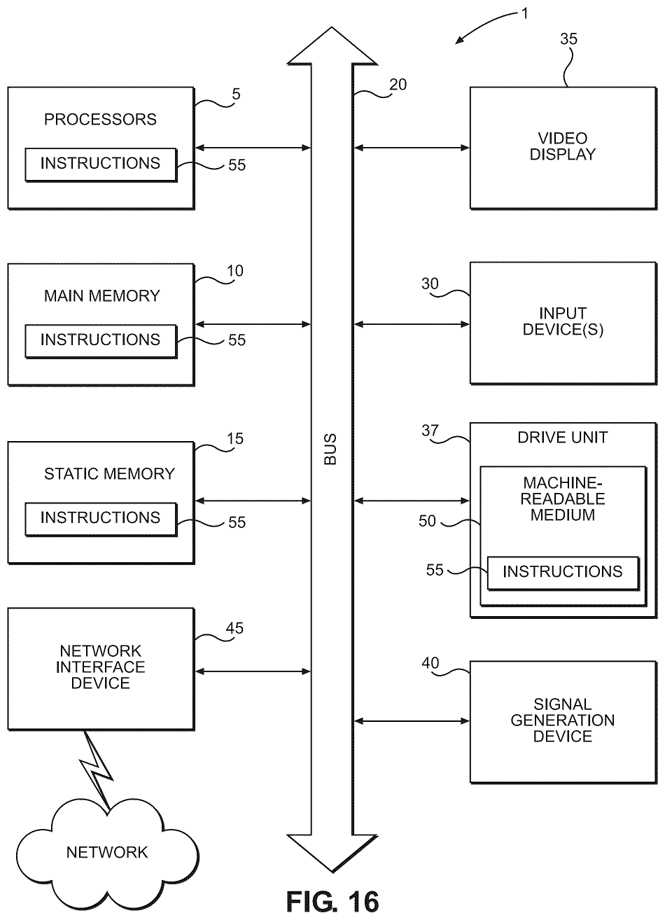

FIG. 16 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be an Internet-of-Things device or system, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 of FIG. 11 are those typically found in computer systems that may be suitable for use with embodiments of the present disclosure and are intended to represent a broad category of such computer components that are well known in the art. Thus, the computer system 1 can be an Internet-of-Things device or system, a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications, as well as wireless communications (both short-range and long-range). Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed:

1. A method, comprising:
receiving, via a sponsorship API, a gas sponsorship request for a user operation from a developer application;
determining, by evaluating the transactions or user operations against a developer's off-chain gas transaction management policy, whether the requested transactions or user operations should be sponsored, the off-chain gas sponsorship policy comprising configurable rules including spending limits, address controls, and temporal parameters;
generating, when the transactions or user operations is determined to qualify for sponsorship, a cryptographic authentication signature that authorizes gas fee coverage for the transaction or user operation;
and
validating, via an ERC-4337 verifying paymaster contract, the authentication signature prior to covering gas fees for the authorized transactions or user operations.

2. The method according to claim 1, further comprising:
receiving the sponsorship request through an API gateway that routes sponsorship requests from external applications;
determining whether the transactions or user operations should be sponsored using a policy engine that retrieves the off-chain gas sponsorship policy from a policy database and enforces the configurable rules;
generating the cryptographic authentication signature using a key manager; and
coordinating the receiving, determining, and generating through a sponsorship service that orchestrates interactions between the API gateway, policy engine, and key manager.

3. The method according to claim 1, further comprising:
associating the off-chain gas sponsorship policy with a designated application API key such that only requests from the designated application API key are accepted;
maintaining the off-chain gas sponsorship policy in a pending status until corresponding blockchain transactions achieve on-chain confirmation; and
updating the off-chain gas sponsorship policy status from pending to finalized upon detection of successful transaction inclusion in confirmed blockchain blocks.

4. The method according to claim 1, further comprising:
storing, in a policy database, the configurable rules including spending limits, transaction value thresholds, and rate limiting parameters; and
tracking, in a sponsorship database, sponsorship commitments from initial authorization through final settlement.

5. The method according to claim 1, further comprising:
continuously monitoring, by a sponsorship indexing module, blockchain networks for events corresponding to pending sponsorships; and
processing, by a billing service, billing events and calculating actual gas costs incurred for successfully completed transactions or user operations.

6. The method according to claim 1, wherein the coordinating through the sponsorship service comprises operating through three distinct phases comprising:
an initial request processing phase that receives incoming sponsorship requests and validates the requests through the API gateway;
a policy evaluation and authorization phase that enforces business rules and generates cryptographic commitments; and
a blockchain monitoring and settlement phase that tracks transaction or user operation confirmations and manages final billing.

7. The method according to claim 1, wherein the sponsorship API:
receives requests for gas sponsorship authentication signatures;
evaluates transactions or user operations against developer-defined policies;
generates authentication signatures for approved operations; and
provides paymaster and data fields for inclusion in the transactions or the user operations.

8. The method according to claim 1, further comprising:
analyzing blockchain transaction data of the transactions or user operations using machine learning algorithms to identify an operation type;
assigning a confidence score to the identified transaction or user operation type using classification algorithms;
comparing the confidence score to a configurable confidence threshold associated with the identified transaction or user operation type; and
determining that the transaction or user operation qualifies for sponsorship when the confidence score meets or exceeds the configurable confidence threshold for the identified operation type.

9. The method according to claim 1, further comprising:
analyzing historical spend rates and market conditions using machine learning algorithms to predict optimal timing for purchasing ETH;
executing ETH purchase transactions through cryptocurrency exchange APIs based on the predicted optimal timing; and
maintaining a shared ETH pool that serves multiple developers to minimize purchase costs and ensure continuous availability for covering the gas fees.

10. The method according to claim 1, further comprising:
analyzing sponsorship usage patterns using adaptive learning algorithms to predict when funds available for covering gas fees will be depleted;
generating severity-based alerts for developer intervention based on the predicted fund depletion timing; and
reducing false positive alerts by incorporating developer feedback into the adaptive learning algorithms.

11. The method according to claim 1, further comprising:
monitoring user spending patterns to establish normal behavior baselines using adaptive learning modules;
detecting anomalies in spending velocity, transaction or user operation frequency, and usage amounts;
automatically implementing protective measures including spending restrictions and account limitations when suspicious activity is identified; and
providing configurable alert and blocking mechanisms based on developer-defined security preferences.

12. A system, comprising:
a processor; and
a memory for storing instructions, the instructions being executed by the processor to:
receive, via a sponsorship API, a sponsorship request for a user operation from a developer application;
determine, by evaluating the user operation against a developer's off-chain gas management policy, whether the requested user operation should be sponsored, the off-chain gas management policy comprising configurable rules including spending limits, address controls, and temporal parameters;
generate, when the user operation is determined to qualify for sponsorship, a cryptographic authentication signature that authorizes gas fee coverage for the user operation; and
validate, via an ERC-4337 verifying paymaster contract, the authentication signature prior to covering gas fees for the authorized user operation.

13. The system according to claim 12, wherein the processor is further configured to:
receive the sponsorship request through an API gateway that routes sponsorship requests from external applications;
determine whether the user operation should be sponsored using a policy engine that retrieves the off-chain gas sponsorship policy from a policy database and enforces the configurable rules;
generate the cryptographic authentication signature using a key manager; and
coordinate the receiving, determining, and generating through a sponsorship service that orchestrates interactions between the API gateway, policy engine, and key manager.

14. The system according to claim 12, wherein the processor is further configured to:
implement machine learning algorithms for dynamic fund allocation based on user revenue potential, the machine learning algorithms comprising:
an adaptive learning module that analyzes user behavioral patterns, transaction or user operation frequency,
and historical revenue contributions to predict each user's future revenue generation capability, classification algorithms that categorize users into revenue potential tiers based on their predicted value to the application;
automated fund allocation systems that assign dynamic spending limits corresponding to each user's revenue category,
wherein users with higher predicted revenue potential receive larger fund allocations.

15. The system according to claim 12, wherein the processor is further configured to:
implement adaptive learning modules that detect malicious activity patterns and implement automated safeguards to protect sponsored funds, wherein the adaptive learning modules:
monitor user spending patterns to establish normal behavior baselines; detect anomalies in spending velocity, transaction or user operation frequency, and usage amounts;
automatically implement protective measures including spending restrictions and account limitations when suspicious activity is identified; and
provide configurable alert and blocking mechanisms based on developer-defined security preferences.

16. The system according to claim 12, wherein the processor is further configured to:
analyze blockchain transaction data of the user operation using machine learning algorithms to identify a transaction or user operation type;
assign a confidence score to the identified transaction or user operation type using classification algorithms;
compare the confidence score to a configurable confidence threshold associated with the identified operation type; and
determine that the transaction or user operation qualifies for sponsorship when the confidence score meets or exceeds the configurable confidence threshold for the identified user operation type.

17. The system according to claim 12, wherein the processor is further configured to:
analyze historical spend rates and market conditions using machine learning algorithms to predict optimal timing for purchasing the native token of the blockchain;
execute ETH purchase transactions through cryptocurrency exchange APIs based on the predicted optimal timing; and
maintain a shared ETH pool that serves multiple developers to minimize purchase costs and ensure continuous availability for covering the gas fees.

18. The system according to claim 12, wherein the processor is further configured to:
analyze sponsorship usage patterns using adaptive learning algorithms to predict when funds available for covering gas fees will be depleted;
generate severity-based alerts for developer intervention based on the predicted fund depletion timing; and
reduce false positive alerts by incorporating developer feedback into the adaptive learning algorithms.

19. A method comprising:
providing a user interface configured to receive policy creation inputs;
receiving policy configuration data comprising a policy name and an identifier of an associated application;
configuring spending control parameters comprising maximum monetary amounts per transaction, maximum monetary amounts per user operation; maximum aggregate monetary amounts per time period, maximum number of transactions or user operations per address, and maximum number of transactions or user operations per policy;
configuring address control parameters comprising at least one of: (i) an address allowlist that restricts usage of the off-chain gas sponsorship policy to predetermined authorized wallet addresses, or (ii) an address blocklist that excludes predetermined prohibited wallet addresses from the gas sponsorship policy;
defining temporal control parameters comprising a policy duration period during which the gas sponsorship policy will remain in effect, and one or more sponsorship expiry periods that define time limits for authentication signatures to remain valid after generation;
validating the policy configuration through a policy engine that retrieves applicable policies from a policy database and enforces policy rules;
storing the policy in the policy database and marking the policy as active for operational use upon successful validation;
associating the policy with the associated application through the application's API key such that the policy accepts only requests sent through the API key of the associated application and rejects all other requests;
implementing API key verification mechanisms via an API gateway and sponsorship service to automatically reject requests from unauthorized applications; and
providing policy management tools through the user interface for editing and updating published policies, wherein policy modifications trigger re-validation through the policy engine before becoming effective.

20. The method according to claim 19, wherein configuring the spending control parameters further comprises:
setting daily spending limits that reset at predetermined intervals;
defining per-user spending caps that accumulate across multiple transactions; and
establishing emergency spending thresholds that trigger automatic policy suspension.

21. The method according to claim 19, wherein the address allowlist comprises:
wallet addresses of verified users who have completed identity verification processes;
contract addresses of approved smart contracts authorized for sponsored transactions or user operations; and
administrative addresses with elevated privileges for policy management.

22. The method according to claim 19, wherein defining the temporal control parameters further comprises:
setting different sponsorship expiry periods for different types of transactions or user operations;
configuring automatic policy renewal options with updated parameters; and
establishing grace periods for policy transitions to prevent service interruptions.

23. The method according to claim 19, wherein validating the policy configuration comprises:
checking for conflicts with existing active policies;
verifying that spending limits do not exceed available funds; and
confirming that temporal parameters do not overlap with restricted time periods.

24. A system comprising:
a processor; and
a memory for storing instructions, the instructions being executed by the processor to:
provide a user interface configured to receive policy creation inputs;
receive policy configuration data comprising a policy name and an identifier of an associated application;
configure spending control parameters comprising maximum monetary amounts per transaction; maximum monetary amounts per user operation, maximum aggregate monetary amounts per time period, maximum number of transactions or user operations per address, and maximum number of transactions or user operations per policy;
configure address control parameters comprising at least one of: (i) an address allowlist that restricts usage of the off-chain gas sponsorship policy to predetermined authorized wallet addresses, or (ii) an address blocklist that excludes predetermined prohibited wallet addresses from the gas sponsorship policy;
define temporal control parameters comprising a policy duration period during which the gas sponsorship policy will remain in effect, and one or more sponsorship expiry periods that define time limits for authentication signatures to remain valid after generation;
validate the policy configuration through a policy engine that retrieves applicable policies from a policy database and enforces policy rules;
store the policy in the policy database and mark the policy as active for operational use upon successful validation;
associate the policy with the associated application through the application's API key such that the policy accepts only requests sent through the API key of the associated application and rejects all other requests;
implement API key verification mechanisms via an API gateway and sponsorship service to automatically reject requests from unauthorized applications; and
provide policy management tools through the user interface for editing and updating published policies, wherein policy modifications trigger re-validation through the policy engine before becoming effective.

25. A non-transitory computer-readable storage medium storing instructions that, when executed by one or more processors, cause the processors to perform operations comprising:
receiving, via a sponsorship API, a sponsorship request for a transaction or a user operation from a developer application;
determining, by evaluating the user operation against a developer's off-chain gas sponsorship policy, whether the requested user operation should be sponsored, the off-chain gas sponsorship policy comprising configurable rules including spending limits, address controls, and temporal parameters;
generating, when the user operation is determined to qualify for sponsorship, a cryptographic authentication signature that authorizes gas fee coverage for the user operation; and
validating, via an ERC-4337 verifying paymaster contract, the authentication signature prior to covering gas fees for the authorized user operation.

26. A non-transitory computer-readable storage medium storing instructions that, when executed by one or more processors, cause the processors to perform operations comprising:
providing a user interface configured to receive policy creation inputs;
receiving policy configuration data comprising a policy name and an identifier of an associated application;
configuring spending control parameters comprising maximum monetary amounts per transaction, maximum monetary amounts per user operation, maximum aggregate monetary amounts per time period, maximum number of user operations per address, and maximum number of user operations per policy;
configuring address control parameters comprising at least one of: (i) an address allowlist that restricts usage of the off-chain gas sponsorship policy to predetermined authorized wallet addresses, or (ii) an address blocklist that excludes predetermined prohibited wallet addresses from the gas sponsorship policy;
defining temporal control parameters comprising a policy duration period during which the gas sponsorship policy will remain in effect, and one or more sponsorship expiry periods that define time limits for authentication signatures to remain valid after generation;
validating the policy configuration through a policy engine that retrieves applicable policies from a policy database and enforces policy rules;
storing the policy in the policy database and marking the policy as active for operational use upon successful validation;
associating the policy with the associated application through the application's API key such that the policy accepts only requests sent through the API key of the associated application and rejects all other requests;
implementing API key verification mechanisms via an API gateway and sponsorship service to automatically reject requests from unauthorized applications; and
providing policy management tools through the user interface for editing and updating published policies, wherein policy modifications trigger re-validation through the policy engine before becoming effective.
